(19) United States
(12) Patent Application Publication
(10) Pub. No.: US 2008/0011091 A1
(43) Pub. Date: Jan. 17, 2008

(54) METHOD FOR MEASURING LOADING AND TEMPERATURE IN STRUCTURES AND MATERIALS BY MEASURING CHANGES IN NATURAL FREQUENCIES

(75) Inventor: James P. Weldon JR., North Hampton, NH (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Abnaki Systems, Inc., North Hampton, NH (US)

(21) Appl. No.: 11/769,270

(22) Filed: Jun. 27, 2007

Related U.S. Application Data
(60) Provisional application No. 60/816,760, filed on Jun. 27, 2006.

(51) Int. Cl. G01L 1/00

(52) U.S. Cl. 73/766

(57) ABSTRACT

“Resonance Force Sensor” has broad—and in some cases revolutionary—applications throughout aerospace, maritime, transportation, and industrial force sensing as a low cost, embedded, robust, self-calibrating strain-pressure sensor. Applications include but are not limited to structural load measurement, structural health monitoring, fluid and gas line pressure measurement, batch process manufacturing, and other force-sensing applications. When a complex structure, e.g. an aircraft or ground vehicle structure, is so instrumented, the present invention serves as the primary sensory component for a highly accurate, automatic, on-board vehicular weight and balance system. This sensor system can also be used in non-vehicular structures to measure axial, radial or flexural loading, and hence gravitational mass loading, of structural elements and structural systems.

### RELATED APPLICATIONS

This application claims the benefit of provisional U.S. patent application No. 60/816,760, filed on Jun. 27, 2006 and entitled “Method for Measuring Loading and Temperature in Structures and Materials by Measuring Changes in Natural Frequencies.”

### FIELD OF THE INVENTION

The present invention relates to a system for sensing pre-stress or other loadings and temperature in a structure or structural component by exciting certain bending modes in that structure and measuring shifts in the resonant frequencies and phases of selected modes that are caused by changes in temperature and/or the application of force to the structure, such as mechanical force, mechanical impedance force, inertial mass loading, gravitational mass-loading, applied bending moments, and applied torsion.

### BACKGROUND

The present invention enjoys certain technical advantages over commonly employed prior art strain and pressure sensing systems that typically employ strain gauge, linear displacement sensors, inductive proximity sensors, or pressure transducers as active sensing elements. These prior art devices generally fail to meet the operational needs of aircraft and ground vehicle operators for certain applications including weight and balance measurement, structural health monitoring, and combat damage assessment. Compared to prior art systems, the present invention exhibits superior measurement accuracy, measurement repeatability, robustness, maintainability, affordability, sensor size, and ease of sensor implementation in individual vehicle applications.

Strain gages provide limited utility in harsh operational environments such as aircraft landing gear and truck axles because of a number of fundamental disadvantages, including bonding, fragility, thermal and electronic drift and structural integrity problems.

Bonding problems: Strain gage bonding agents act as intermediate buffers between the strain gage and the structure under measurement. The gage effectively measures the strain of the bonding agent, as opposed to directly measuring strain in the substrate or structural material. Additionally, the process of bonding strain gages to a structural surface produces non-uniform bonding agent thickness; each gage effectively exhibits a unique response function. Failure and replacement of a plurality of strain gages generally necessitates a system recalibration, as it is highly unlikely that the electrical output voltage produced by replacement gages will duplicate the output generated by the original transducers.

Fragility problems: The active strain-sensing elements within strain gauge transducers are very fine wires which are susceptible to damage from handling during shipment or storage, during installation, and from shock loads and impacts normally imposed on the transducers during system operation. Replacing broken strain gages reintroduces the problems associated with non-uniform bonding, variable gage response to strain, and system recalibration.

Thermal drift: The resistance in the strain sensitive elements tends to change with the surrounding temperature (thermal drift), thereby generating erroneous electrical output signals unless a system compensates for changes in temperature. Typically, temperature compensation systems are also sensitive to non-temperature related inputs, and sophisticated temperature compensating components are frequently required.

Contamination: Strain gage transducers produce very small electrical output voltage, usually on the order of a few millivolts, while relying on significant internal changes in electrical resistance to affect the strain measurement. Strain gage system accuracy can be severely reduced by any low impedance electrical leakage caused by the introduction of moisture or other contaminants within the transducer or in the wiring to the transducer.

Localization: Individual strain gages are sensitive only to highly localized changes in strain. Small numbers of strain gages produce poor measurement repeatability, as individual strain gages do not capture information describing variations in structural load path.

Inductance and Linear Displacement Load Sensors: Inductance and linear displacement sensors suffer from a number of inherent disadvantages that make them unsuitable for a majority of aircraft and ground vehicle weight and balance applications.

Localization: Inductance sensors and linear displacement sensors produce an output voltage based on the displacement of their mechanical attachment points, with the assumption being that displacement is the result of strain. Inductance and linear displacement sensors, therefore, do not capture information that results from variations in structural load paths.

Implementability: Inductance and linear displacement sensors require at least two co-located secure mechanical mounting points per sensor, a requirement that limits the number of structural components and locations within a vehicle or other structure that are suitable for sensor implementation.

Load Cell Sensors: Load cells are generally strain-gauge based sensors are implemented contiguously along a structural load path within a structure, in order to directly sense load. The act of incorporating load cells contiguously into a structure raises safety, structural integrity, retrofit, and maintainability-replacement concerns.

It is therefore a goal of the present invention to provide a self-calibrating sensor and sensor system that alleviates at least some of the deficiencies of strain gage, inductance, linear displacement and pressure type transducers and sensors for purposes of determining structural pre-stress and overall structural load in operationally challenging environments such as air, ground and sea transportation applications, fluid and pressure lines, and other structures.

### SUMMARY

The present invention relates to a system for sensing pre-stress or other loadings and temperature in a structure or structural component by exciting one or more bending modes in that structure and then sensing the changes in the associated resonant frequencies or phases that are caused by changes in loading of the structure and by changes in temperature. These vibrational identifiers provide a robust and cost-effective solution to the challenges of measuring of applied load, load distribution and temperature in all manner of mechanical structures, from the very small (one dimensional strings and two dimensional membranes) to the large (three dimensional structures such as beams, columns, trusses, tubes, pressure lines, and shells).

In a basic embodiment, the present invention employs ambient vibrations or “vibrational daylight” to stimulate standing waves and associated natural structural modes. The resulting standing waves are sensed by one or more receivers, or sensors, which can be attached, placed or embedded spatially along the structural element in such a way so as to filter out unwanted modes and minimize unwanted standing wave activity, thus increasing sensitivity to the resonant modes of interest. Changes in loading or pre-stress on the subject structure or subject structural component change the exact nature of the resonant modes of interest. These changes are manifested by shifts in the resonant frequencies of the modes of interest and by certain phase shifts associated with these resonant frequency shifts. The receiving acoustic sensor identifies and tracks resonance frequencies, and transmits resonance frequency information to a point or network collection site. This tagged frequency information is then analyzed at the collection point, creating a “modal map” of the structure, effectively converting the structure into a self-sensing load bearer.

In another general embodiment, a standing wave is generated in a subject structural component by one or more actuators, which are placed, attached or embedded spatially on the structural component in such a way as to optimize the excitation of the intended resonant modes. The resulting standing wave is sensed by one or more receivers, or sensors, which can be attached, placed or embedded spatially along the structural element in such a way so as to filter out unwanted modes and minimize unwanted standing wave activity, thus increasing sensitivity to the resonant modes of interest. Changes in loading or pre-stress on the subject structure or subject structural component change the exact nature of the resonant modes of interest. These changes are manifested by shifts in the resonant frequencies of the modes of interest and by certain phase shifts associated with these resonant frequency shifts. As in the primary embodiment, the tagged frequency information is then analyzed at the collection point, creating a “modal map” of the structure, effectively converting the structure into a self-sensing load bearer.

A key facet in one embodiment of the system is temperature measurement, temperature compensation and self-calibration. Structural modes and the associated natural frequencies of vibration are highly sensitive to changes in structural material temperature. Certain modes respond to both changes in material temperature and to changes in pre-stress loading, while other modes respond to changing temperature but not to changes in pre-stress loading. These mechanisms make possible a self-calibration capability that uses a temperature metric, and is accomplished by exciting and monitoring at least two modes in a structure, the first being a mode that responds only to temperature change, the second being a mode that responds to both temperature change and to the pre-stress load of choice. In this procedure, a mode that is sensitive to temperature but not sensitive to the applied pre-stress determines the localized structural material temperature state. This localized temperature information is then used to calibrate any mode that responds to both temperature and the desired pre-stress for purposes of determining both material temperature and applied load.

The present invention measures structural material temperature and all forms of structural pre-stress, including axial compressive and tensile loading, applied bending moments, applied torsion, gravitational mass loading, and inertial mass loading by measuring changes in the structure's resonant response to excitation in certain bending modes.

Preferred embodiments of the invention may achieve one or more of the following objectives:

It is one objective of the present invention to provide a Resonance Force Sensor that eclipses the performance of prior art sensors made for the purpose of measuring pre-stress in structures or structural components by measuring how changes in pre-stress affect the dynamical behavior of the structure. Pre-stress is hereby defined as any combination of axial tension or compression, applied bending moments and torque, and gravitational and inertial mass loading. Structural beams, columns, shells, and membranes exhibit certain natural frequencies of vibration and associated modes of deformation, and these natural or resonant frequencies and the associated phases change when the structure experiences changes in pre-stress loading and temperature. In the present invention, structural pre-stress loading is determined by measuring changes in the structure's resonant frequencies and phases, thereby alleviating many problems found in prior art load sensors, and enabling operators to glean real time load information using small, robust, inexpensive, easily adapted actuator and sensing components.

It is a further objective of the present invention to provide a Resonance Force Sensor system that consistently and accurately measures the effects of changes in a structure's temperature on changes in that structure's resonance frequencies and phases, and utilizes that temperature information to more accurately measure changes in that structure's pre-stress loading. Structural beams, columns, shells, and membranes exhibit certain natural frequencies of vibration and associated modes of deformation, and these natural or resonant frequencies and phases change when the structure experiences changes in pre-stress loading and temperature.

It is a further object of the present invention to provide a “self-calibration” capability that uses resonance frequency response to temperature change as a metric. Structural modes and associated natural frequencies of vibration are sensitive to changes in structural temperature. Certain modes are responsive to both changes in material temperature and to changes in pre-stress loading, while other modes are responsive to changing temperature but are not responsive to changes in pre-stress loading. By exciting and monitoring multiple modes in a structure, the first being a mode that responds only to temperature change, the others beings modes that respond to both temperature change and to the pre-stress load of choice, it is possible to measure and self-calibrate for temperature variations, and accurately measure desired pre-stress.

A further objective of the present invention is to provide a Resonance Force Sensor assembly that is capable of accurately measuring very small changes in axial compressive or tensile loading, small applications of bending moments and/or torque, the effects of small changes in inertial mass or gravitational mass, and small changes in temperature.

It is a further objective of the present invention to provide a Resonance Force Sensor that uses ambient noise, or “vibrational daylight,” as the source of vibration to excite natural frequencies and modes in the structure under measurement. In this embodiment, components of the present “Resonance Force Sensor” invention acquire and process information pertaining to changes in a structure's resonance frequencies that are excited by some ambient source, such as engine or propulsion system operation, or other general macro or micro vibration sources.

It is a further objective of the present invention to provide a Resonance Force Sensor that employs components to directly excite certain resonant states, and then measures the relationship between amplitudes at various frequencies of a plurality of excitation and sensing elements. By doing this, the present invention creates a dynamic signal and compares the ratios of a plurality of actuator signal amplitudes to sensor signal amplitudes at various frequencies. In contrast, the strain gage and inductance sensor prior art employ static signals to generate measurements of the absolute amplitude of an individual sensor's response to strain. As this embodiment of the Resonance Force Sensor measures a ratio-ed dynamic signal, rather than an absolute static signal, the present invention is less sensitive to arbitrary signal variations caused by noise, temperature, stiction, and friction. In this embodiment, the absolute value of the amplitude is not critical, only the frequency at which a ratio-ed maximum occurs while data is being taken.

Another objective of the present invention is to provide a Resonance Force Sensor assembly that produces a repeatable, high level output signal proportional to the load carried by the member being monitored and over a wide variation in such load.

It is a further objective of the present invention to provide a means for directly measuring changes in a structure's pre-stress and/or temperature by direct measurement, in contrast to the strain gage, which measures its own change in resistivity as strain is transferred through layers of bonding materials, or the inductance sensor, which generates a signal based on its own internal displacements. The present invention directly measures changes in prestress and temperature by measuring changes in the structure's resonance frequencies and phases caused by changes in pre-stress and/or temperature.

It is a further object of the present invention to measure and employ the effects on resonance frequencies and phases caused by changes in a structure's temperature and thereby minimize thermal drift as a measurement concern.

It is another objective of the present invention to provide a Resonance Force Sensor that does not rely on an absolute DC signal, and instead measures a ratio-ed AC signal, making the sensor system measurement performance much less susceptible to variations in output voltage. The embodiment of the Resonance Force Sensor that measures the shift in resonant frequency by monitoring the ratio of the sensor (or receiver) output signal to the actuator (or input) signal is less susceptible to contamination and reduced performance caused by moisture or other contaminants. In contrast, strain gage transducers combine significant source resistance with a very small electrical output voltage so that any electrical leakage either within the transducer or in the wiring to the transducer may significantly reduce the accuracy of the strain gage system. In the Resonance Force Sensor invention that measures a ratio-ed AC signal, the absolute value of the amplitude is not critical, only the frequency at which a ratio-ed maximum occurs while data is being taken.

Yet another objective of the present invention is to provide a robust Resonance Force Sensor assembly that withstands the harsh environments and shock loads associated with aircraft landing gears, truck and train axles, and other harsh vehicular or propulsion-related operating environments. This ruggedness is achieved by the use of various bolt-on, clamp-on and remotely operated excitation, sensing and data acquisition and processing mechanisms.

It is a further objective of the present invention to provide a robust Resonance Sensor that exhibits a very high mean-time-between-failure (MBTF).

It is another objective of the present invention to capture accurate load information for a structural component in the presence of changes in structural load path within that structural component. By virtue of the nature of wave propagation in media, and the proper placement of actuators and receivers, the present invention senses component response to load by measuring changes in the dynamic characteristics of the material in the path length of the invention's induced signal. Hence, the present invention acts to capture component load information in the path length of the invention's induced signal rather than sensing changes at a particular point in the structure. In contrast, the strain gage and inductance sensor prior art measure strain only at the point where the sensor is bonded or bolted.

Another objective of the present invention is to provide a Resonance Sensor assembly that can be mounted directly to the structural member in which the load being carried, thereby directly measuring the dynamic deformation of the structural member under load. The Resonance Sensor system is capable of being mounted to a structure by a variety of mechanisms—such as clamps, bolts and bonding—for attaching the actuating and receiving elements to the subject structure.

It is also an objective of the present invention to provide a Resonance Sensor assembly which does not contribute to or detract from the load carried by the member being monitored, nor impart any significant preload to the attachment points of the actuation or sensing elements or to the member being measured thereby preventing any unpredictable distortion of the loaded member or the attachment points.

It is a further objective of the present invention to provide a Resonance Sensor system that, in contrast with certain embedded load cell application of prior art, presents no danger to structural integrity.

It is a further objective of the present invention to provide a Resonance Sensor system that is substantially less sensitive than a strain gage to the detrimental effects of the bonding agent. In contrast to the strain gage, no significant damping, attenuation or other degradation of the Resonance Sensor signal occurs due to small variations in bonding agent thickness. Small variations in bonding agent thickness have a negligible effect on the transfer of the vibration between the piezo or magneto-resistive sensing or actuation elements and the structure.

It is a further objective of the present invention to provide a Resonance Sensor system that can be expanded into a network with a plurality of actuators and receivers so as to capture broader structural information, minimize the effects of variations in structural load path, and be adapted to any structural geometry or mechanical requirement. The Resonance Sensor is particularly suited to this purpose as the system senses the structure's response to changes in pre-stress by looking at changes in the dynamic characteristics of the structural material in the path length of the induced signal.

It is a further objective of the present invention to provide a Resonance Sensor system that affords the option of tailoring the physical size and profile of actuator and receiver elements to the specific requirements of the subject structure. The actuator and receiver elements of the Resonance Sensor can be selected from a very broad range of commercially available options. Very small, very low profile commercially available actuator and sensor elements make Resonance Sensor implementable in critical structural areas while minimizing the potential for structural or mechanical interference, and greatly expanding the scope of potential structural locations for sensor use. Individual actuator and receiver components can be as small or as large as required by the individual application. This is in contrast to the inductance sensors of the prior art, especially the ones specifically adapted to aircraft strain measurements that suffer from limitations on minimum sensor size, and from a large three-dimensional sensor profile.

It is a further objective of the present invention to provide a Resonance Sensor system that is composed of very lightweight actuation and sensing elements. The sum of Resonance Sensor system components amounts to a very small incremental weight relative to the structures it can be placed on. As opposed to the pressure transducer methodologies of Nance and others, the Resonance Sensor approach requires no pumps or mechanical plumbing.

It is a further objective of the present invention to provide a Resonance Sensor system that is composed of inexpensive components, including the actuation and sensing elements. The actuator and receiver elements of the Resonance Sensor can be selected from a very broad range of commercially available options. The electronics required to control the measurement process and perform the necessary computations, can easily be made from off-the-shelf components for a relatively inexpensive system cost.

### BRIEF DESCRIPTION OF THE FIGURES

The invention will be more fully understood from the following detailed description taken in conjunction with the accompanying drawings in which:

FIG. 1 provides a diagrammatic representation of an exemplary resonance load sensor system of the invention;

FIG. 2 provides a plot of amplitude versus frequency for a resonance load sensor system and method of the invention showing convergence at higher order bending modes;

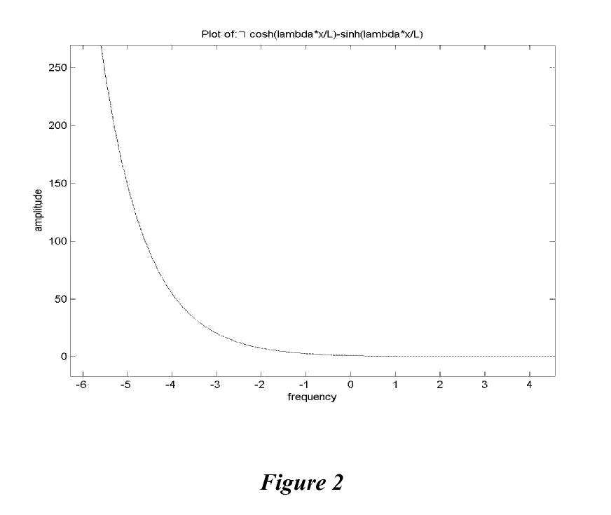

FIG. 3 illustrates a measurement of changing resonance frequency with varying load according to an embodiment of the invention;

FIG. 4 illustrates a measurement of changing resonance frequency and changing phase angle according to embodiments of the invention;

FIG. 5 further illustrates a measurement of changing phase angle according to an embodiment of the invention;

FIG. 6 shows the system of FIG. 1 applied to a landing gear;

FIG. 7 shows the system of FIG. 1 applied to an air plane;

FIG. 8 shows the system of FIG. 1 applied to a helicopter;

FIG. 9 shows the system of FIG. 1 applied to a ground-based vehicle; and

FIG. 10 shows the system of FIG. 1 applied to a static structure.

### DETAILED DESCRIPTION OF THE INVENTION

The present invention relates to a system for sensing load (often referred to herein as “pre-stress load”) and temperature in a structure or structural component by exciting certain bending modes in that structure and measuring shifts in the resonant frequencies and phases of selected higher order modes that are caused by changes in loading and by changes in temperature in the structure. This load sensing system is referred to herein as a Resonance Force Sensor.

Resonance Force Sensing is based on the physical principle that a structural beam, column, plate shell or membrane exhibits certain natural frequencies of vibration and associated modes of deformation. One dimensional strings, two dimensional membranes, and three dimensional structures such as beams, cylinders, columns shells and plates exhibit certain natural frequencies of vibration and associated modes of deformation. A common example of is the guitar string, which exhibits a change in tone as it is stretched or loosened. Similarly, the harmonics (or natural frequencies of vibration) of two and three dimensional structures and materials change in response to axial loading, applied torsion, applied bending moments, applied radial force, and changes in temperature.

This mechanism that links changes in a structure's loading and temperature to changes in resonant frequency can be utilized as a strain-pressure-temperature sensor by exciting certain structural bending modes and tracking the subsequent resonant responses to applied loading and temperature change. By using calibration data, it is then possible to convert these measurements of change in resonant frequency and phase into measurements of pre-stress and temperature in a structure, including information that describes axial compression and tension, torsion, applied bending moments, temperature, and both inertial mass loading and gravitational mass loading. This mechanism that links changing natural frequencies to changes in pre-stress and temperature exhibits the following general characteristics:
Certain natural frequencies (or modes) respond to structural pre-stress, including axial compression and tension, torsion, bending moment application, thermal loading, and gravitational and inertial mass loading.
Structural modes are sensitive to temperature change.
Certain modes are sensitive to changes in both temperature and pre-stress, while other modes respond to changing temperature but not to pre-stress. This makes possible a self-calibrating load sensing capability that uses a temperature metric.

This “Resonance Force Sensing” mechanism makes possible fundamentally new force and temperature sensing applications, such as the real-time measurement of operational loading, combat damage and structural health in aircraft, ships and ground vehicles, and advanced self-calibrating maritime pressure and strain sensing for automated propulsion and weighing systems. The present invention's technical advantages will enable such applications as:
Measurement of structural force, torsion, bending, load path, load magnitude and temperature in all aeronautical and astronautical structures, ground vehicles, and maritime vehicles generating design information to enable designers to optimize structural material properties and designs. (minimize structural steel—lighter, less expensive vehicles)
Self calibrating sensors for maritime hull and mechanical force, torsion, bending, pressure and temperature sensing (DD-21 and CVX automated ship initiatives)
SSN/SSBN/SSGN automated mass and mass distribution measurement (With modular payloads being implemented into SSN hulls, SSN's will face the same payload management problems as aircraft.)
Combat damage assessment systems for air, sea and ground vehicles that employ embedded “Resonance Force Sensors” would generate and monitor a “modal state analysis map” of the vehicle, and differentiate between mass carriage changes (weapons or ordnance delivery, fuel burn, payload drop), and re-directed load paths that result from the loss of structural integrity due to combat damage.
Structural Health Monitoring systems for air, ground and sea vehicles.
Automated, on-board real-time weight and balance systems for air, ground and sea vehicles.
Highly accurate and non-invasive fluid-line and pressure-line measurement systems that simultaneously monitor fluid or gas pressure, line structural health, and identify the location of leaks and cracks.

The effects of prestress on these modes and natural frequencies are in evidence everywhere, and can be seen most dramatically in string instruments where tone is changed by increasing or decreasing tension. The effects of prestress on structures that support flexure and torsion are no less powerful: the frequency and phase manifestations of a structure's harmonics change with changes in prestress and with changing temperature. This mechanism forms the basis for the method of the present invention in measuring static load and load distribution in 2 and 3 dimensional structures and structural components such as membranes, beams, columns, shells, and plates.

The literature contains one well-established theory (Euler-Bernoulli Theory) that supports the existence of a fundamental physical mechanism for determining the axial loading of a beam element. For a beam under prestress, the Euler-Bernoulli Beam Equation is:

$$\frac{{\partial }^{4} y ( x , t )}{\partial {x}^{4}} - \frac{{T}_{n}}{EI} \frac{{\partial }^{2} y}{\partial {x}^{2}} + \frac{ρ A}{EI} \frac{{\partial }^{2} y ( x , t )}{\partial {t}^{2}} = 0 ,$$

where y(x, t) is the transverse deformation of the beam, ρ(x) is mass density, E is Young's modulus of elasticity, I(x) is the cross sectional moment of inertia, and Tₙ is the applied tension (negative Tₙ is compression). The solution to the Euler Bernoulli equation for a beam is
y=Y(x)e^{(-iωx)}.
Using the example of “pinned-pinned” boundary conditions where “l” is the length
Y(0)=Y″(0)=Y(l)=Y″(l)=0
reduces the equation to

$$\frac{{ⅆ}^{4} Y}{ⅆ {x}^{4}} - \frac{{T}_{n}}{EI} \frac{{ⅆ}^{2} Y}{ⅆ {x}^{2}} - \frac{{ω}^{2} ( ρ A )}{EI} Y = 0.$$

The natural frequencies are the eigenvalues are given by:

$${ω}_{n} = \frac{{n}^{2} {π}^{2}}{{l}^{2}} \sqrt{( \frac{EI}{ρ A} ) {( 1 + \frac{( {T}_{n} ) ( {l}^{2} )}{{n}^{2} {π}^{2} EI} )}^{1 / 2}} .$$

Euler-Bernoulli therefore defines the natural frequency of the vibrating pinned beam as a function of tension, or more generally, axial compressive or tensile load, suggesting the existence of the basic mechanism of Resonance Force Sensing that links changes in prestress to changes in natural frequency. An analytic extension of Euler Bernoulli beam theory that involves both local effects and a

$${( \frac{k}{m} )}^{\frac{1}{2}}$$

response confirms actual data acquired from invention prototypes when measuring the effects on natural frequency of applied tensile and compressive loading, torsion and bending.

Resonance frequencies are highly sensitive to temperature. When employing the method of “Resonant Load Sensing” or “Resonance Force Sensing”, it is necessary to consider the temperature effects on the excited resonant frequencies in order to employ those frequency measurements as a means of measuring applied force.

The theory behind temperature effects on excited resonant frequencies, and hence on the mechanism that links changes in prestress loading to changes in resonance frequencies, can be understood by examining the variation of Young's modulus of a material with temperature. As an example, a simple steel beam with free-free boundary conditions demonstrates how changes in material temperature affect structural resonance frequency response to prestress. The Young's modulus can be written as a function of temperature as

$$E ( T ) = {E}_{0} + \frac{\partial E}{\partial T} ( T - {T}_{0} ) = {E}_{0} + β Δ T$$

where “E” is the Young's modulus at the measuring temperature, “E₀” is the Young's modulus at the reference temperature, “T” is the measuring temperature, “T₀” is the reference temperature, and “β” is the linear change in Young's modulus with respect to temperature.

It is also known that the coefficient of linear thermal expansion of steel is approximately constant over a small temperature range, so that structural dimensions can be written as functions of temperature:
w=w₀+(1+αΔT)
l=l₀+(1+αΔT)
t=t₀+(1+αΔT)
where “w” is the width of the beam, “w₀” is the reference width of the beam, “l” is the length of the beam, “l₀” is the reference length of the beam, “t” is the thickness of the beam, “t₀” is the reference thickness of the beam, and “α” is the mean coefficient of linear thermal expansion.

Because of thermal expansion, the beam density per unit volume varies with temperature. Since the mass of the beam remains the same regardless of temperature and the beam is assumed to be isotropic:

$$ρ = \frac{M}{V} = \frac{M}{{w}_{0} {l}_{0} {{t}_{0} ( 1 + α Δ T )}^{3}} = \frac{M}{{{V}_{0} ( 1 + α Δ T )}^{3}} = \frac{{ρ}_{0}}{{( 1 + αΔ T )}^{3}}$$

where “M” is the mass of the beam, “ρ” is the mass density of the beam, “ρ₀” is the mass density of the beam at the reference temperature, “V” is the volume of the beam, and “V₀” is the volume of the beam at the reference temperature.

The resonance frequencies generated from the Euler Bernoulli equation for a free-free beam in bending are

$${ω}_{n} = \frac{{β}_{n}^{2}}{2 π} \sqrt{\frac{EI}{ρ A}} ,$$

where “ωₙ” is the natural frequency in Hz of the nth bending mode, “βₙ” is the weight for the n^{th} bending mode, I is the area moment of inertia of the beam, and A is the area of the cross section of the beam. For a beam with a constant rectangular cross section, the area moment of inertia

$$I = \frac{w {t}^{3}}{12}$$

and the area of the beam cross-section is A=wt. The natural frequency of a free-free steel beam can be rewritten to account for the temperature dependency of the material properties:

$${ω}_{n} = \frac{{( {β}_{n} l )}^{2} {t}_{0}}{4 π {l}_{0}^{2}} \sqrt{\frac{( {E}_{0} + β Δ T ) ( 1 + α Δ T )}{3 {ρ}_{0}}} .$$

The resulting resonant frequency at the reference temperature is then:

$${ω}_{n 0} = \frac{{( {β}_{n} l )}^{2} {t}_{0}}{4 π {l}_{0}^{2}} \sqrt{\frac{{E}_{0}}{3 {ρ}_{0}}} ,$$

and the ratio of resonant frequency shifting with temperature is:

$$\frac{{ω}_{n}}{{ω}_{n 0}} = \sqrt{\frac{( {E}_{0} + β Δ T ) ( 1 + α Δ T )}{{E}_{0}}}$$

For a steel beam with materials parameters
E₀=2.1*10¹¹ N/m², α=6.0*10⁻⁶, β=3.7*10⁷ N/m²,
the term (E₀+βΔT) dominates for changes in temperature, indicating that an increase in temperature leads to a decrease in resonant frequencies, which is exactly the result generated by present invention prototypes.

In a primary embodiment, the Resonance Force Sensor employs ambient vibrations (or “vibrational daylight”) generated by a propulsion, electrical generation or other mechanical system to excite certain resonant modes in a structure or structural component. The resulting waves propagate through the structure and are received by one or more receivers, or sensors, that are positioned spatially on the structural element in such a way so as to minimize unwanted modes and extraneous acoustic noise and increase the receiver's sensitivity for the intended resonant modes. Changes in pre-stress loading and changes in material temperature cause both the frequency and the phase of certain excited resonant modes to shift. The present invention measures these frequency and phase shift changes, and by employing the proper data acquisition, data processing, computer memory and storage, associated electrical power, amplification and filtration subsystems, precisely measures the temperature and the applied pre-stress load on the instrumented structural element.

In another embodiment, a network of Radio Frequency Identification Chip—accelerometers (RFID-accelerometer chips) or other structural acoustic sensors with wireless data transmission capability are embedded, bolted, clamped, or otherwise spatially attached to the subject structure or structural element in such a way so as to minimize unwanted modes and extraneous acoustic noise and increase the receiver's sensitivity for the intended resonant modes. These RFID-accelerometer chips monitor ambient vibrations or “vibrational daylight,” identify and track resonance frequencies, and transmit resonance frequency information to a point or network collection site. The tagged frequency information is then analyzed at the collection point, creating a “modal map” of the structure, effectively converting the structure into a self-sensing load bearer.

In another embodiment, the Resonance Force Sensor employs actuators or acoustic exciters to generate certain waves in the structure and thus excite certain resonant states. One or more actuators are placed, embedded, bolted or clamped spatially on the structural element in such a way as to optimize the excitation of the intended resonant modes. The resulting waves propagate through the structure and are received by one or more receivers, or sensors, that are positioned, bolted, clamped or bonded spatially on the structural element in such a way and in such locations and orientations so as to minimize unwanted modes and extraneous acoustic noise and increase the receiver's sensitivity for the intended resonant modes. Changes in prestress loading and changes in material temperature cause both the frequency and the phase of certain excited resonant modes to shift. The present invention measures these frequency and phase shift changes, and by employing the proper data acquisition, data processing, computer memory and storage, associated electrical power, amplification and filtration subsystems, precisely measures the temperature of the material and the applied pre-stress on the instrumented structural element.

In another embodiment, the present invention utilizes the temperature sensitivity of certain longitudinal, radial and flexural bending modes and associated resonant frequencies in order to measure the material temperature. This is accomplished by identifying those modes which are sensitive to temperature but not sensitive to axial, radial or torsional pre-stress, and then employing the proper data acquisition, data calibration, data processing, computer memory and storage, associated electrical power, amplification and filtration subsystems to precisely determine local material temperature. This temperature information is then held in memory and used to calibrate resonant frequency information of other modes that are sensitive to axial, radial or flexural prestress, and hence to determine the magnitude of the localized prestress load.

In another embodiment, the present invention utilizes temperature sensors, such as thermocouples or other temperature sensing devices, to sense local material temperature for purposes of calibrating resonant frequency data. This temperature information is then held in memory and used to calibrate resonant frequency information that is acquired by the sensing of other modes that are sensitive to axial, radial or flexural prestress, and hence to determine the magnitude of the localized prestress load.

In another embodiment, the present invention utilizes “non-contact” or “remote” temperature sensors, such as Infra Red (IR) sensors, to measure the thermal temperature of a structure or structural component in order to acquire temperature information for use in converting a measurement of resonant frequency into a measurement of applied force.

In a still further embodiment, a network of vibrational exciters or actuators is embedded or attached to the structure or structural component in such as way as to generate the desired modal excitation at specific points throughout the structure or structural component. Each individual actuator then acts to excite a desired natural frequency or mode in the subject structural component. This excited mode is then sensed by individual RFID-accelerometer chips or other structural acoustic sensors embedded or attached to the subject structure or structural component in such a way and in such locations and orientations so as to minimize unwanted modes and extraneous acoustic noise and increase the receiver's sensitivity for the intended resonant modes. The receiving accelerometer or acoustic sensor identifies and tracks resonance frequencies, and transmits resonance frequency information to a point or network collection site. As in the prior embodiment, the tagged frequency information is then analyzed at the collection point, creating a “modal map” of the structure, effectively converting the structure into a self-sensing load bearer.

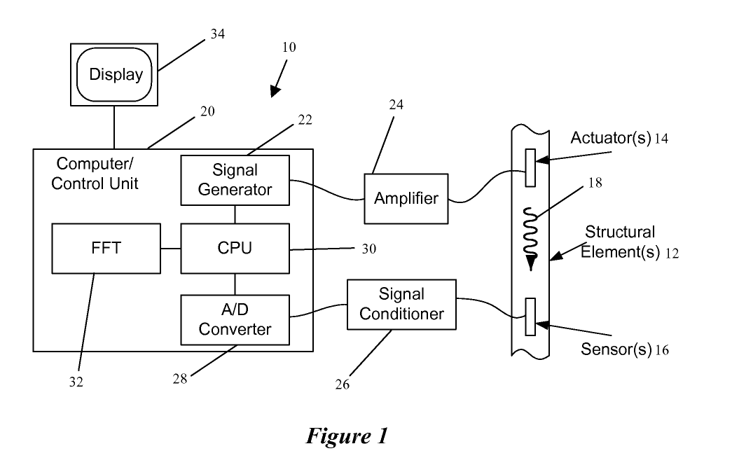

An exemplary system 10 for measuring a load on a structural element 12 is illustrated in FIG. 1. When the above described principles are applied to the control of this system, the system may be used within the spirit of the present invention. This system shows one actuator 14 and one sensor 16 disposed in an axially displaced configuration on structural element 12. A person of ordinary skill in the art will recognize that other configurations are possible and that a plurality of actuators and/or sensors can be deployed depending upon the type of load measurements that are desired. In a preferred embodiment, actuator 14 is a piezoelectric actuator and sensor 16 is a piezoelectric sensor. Actuator 14 could also be another type of actuator that will work with the invention such as, for example, a magnetostrictive actuator. Similarly, sensor 16 could be another type of sensor that will work for the intended purpose within a system of the invention such as, for example, a fiber optic or other strain sensor. The sensor and actuator can be attached to the structural element in any way that allows them to perform their intended function, including by bonding, clamping, or bolting to the structural element. In one embodiment, a piezoelectric actuator 14 or sensor 16 can be created by arranging piezoelectric elements in a stack inside a housing with which the stack is in mechanical contact. The stack can then be bolted to structural element 12 in a way that allows vibrations to created by the actuator to be transferred to the structural element, and vibrations in the structural element to be transferred to the structural element.

A variety of attachment methodologies can be used to attach the sensor to the structural element. A number of these methodologies will include bolts and clamps. The bolts or clamps will have the sensing element such as an accelerometer or piezo, attached. While other attachment methodologies can be used, there are a number of benefits to using clamps or bolts:
1. bolts or clamps can be easily replaced and maintained;
2. instrumented bolts and clamps can be produced off-site to high tolerances;
3. there will be no uncertainty about location or orientation when replacing bolts or clamps—there will be mechanical attachment points;
4. there will no degradation in the sensor due to localized strain—the bolt or clamp will transfer the resonant vibration to the attached sensing element (accelerometer, piezo, whatever)—but the bolt or clamp will not suffer deformation from the localized strain field in the structure. This can be a big problem in using piezos as the sensing element—by directly bonding the piezo to the surface of the structure, the piezo undergoes the same strain as the local structure surface, causing significant problems in piezo performance.

In system 10, a standing wave 18 is generated in structural element 12 by a plurality of actuators 14 disposed on the structural element in such a way as to optimize the excitation of the intended resonant modes. The resulting standing wave 18 is sensed by a plurality of sensors that are attached along the structural element in such a way so as to filter out unwanted modes and minimize unwanted standing wave activity, thus increasing sensitivity to the resonant modes of interest.

The absolute and relative spatial points of attachment of the wave actuators 14 and wave sensors 16 on the surface of the subject structural element 12 is preferably optimized in order to maximize sensitivity to the desired resonant modes and minimize sensitivity to reflected waves or transmitted vibrations from adjacent structures.

In one aspect, in order to minimize sensitivity to wave reflection from the boundaries of the structural element 12, a finite element analysis is performed in order to identify optimal spatial positioning of the wave actuators 14 and wave sensors 16. This is accomplished by modeling wave behavior as it propagates from the actuator through the structural element and interacts or reflects at the boundaries of that particular component or with connecting structural mechanisms. Optimal spatial positioning locates both the wave actuator and wave sensor at points, known as nodes that minimize reflected wave amplitude.

In another aspect, the FE analysis positions both wave actuators 14 and wave sensors 16 on the surface of the structural element 12 in order to maximize sensitivity to the excitation of the intended resonant modes. This is accomplished by positioning wave sensors at a radius of action from the wave actuators that coincides with the anti-nodes, or points of maximum amplitude, of the resonant modes of interest.

In addition to the elements disposed on the structural element 18, system 10 of the invention can include a computer/control unit 20 that can drive the one or more actuators 14 and process signals from the one or more sensors 16. Computer/control unit 20 can be a general purpose computer, such as personal and workstation computers known in the art (as well as other types of general purpose digital computing devices), configured for use with the invention. Or, computer/control unit 20 can be a special purpose digital computing device designed for operation within the scope of the present invention.

In general, computer/control unit 20 includes a signal generator 22 that can be directed to drive one or more actuators 14 at one or more frequencies. An amplifier or amplifiers 24, which can be located on or off of the computer/control unit, process the signals for physical application by the actuators. On the sensor 16 side, a signal conditioner 26 (again, the signal conditioner can be on or off of the computer/control unit) can receive signals from the sensor or sensors 16 and amplify and or filter those signals before passing them along to the computer/control unit 20. On the computer/control unit, an analog to digital converter 28 can receive the signal from the sensor or sensors 16 and process that signal into a digital signal that can further be processed digitally by the computer/control unit 20.

Central processing unit 30 in the computer/control unit is programmed with software to direct signal generator 22 and to process signals from the analog to digital converter 28. A person of ordinary skill in the art will recognize that CPU 30 could be any number of general or special purpose processors available in the art, including vector processors and multiple core or multi-CPU processors. CPU 30 preferably includes a Fast Fourier Transform unit 32 to aid in processing incoming signals from sensor(s) 16, and can be implemented in hardware or in software or firmware on the CPU 30.

The operation or programming of CPU 30 to operate signal generator 22 and to process signals from sensor(s) 16 can best be described by explaining the underlying principles of the invention. The operation of the disclosed embodiments is based on the physical principle that a structural beam or column exhibits certain natural frequencies of vibration and associated modes of deformation, and that changes in the axial, radial or flexural loading of the structure cause a measurable shift in both the structure's resonant frequency of vibration and in the associated phase of the each bending mode.

Identifying the exact modes that are to be excited requires a case-by-case structural analysis (numerical analysis and/or physical experiment) of each structure that is to be instrumented. Mode sensitivity to both temperature and prestress must be measured.

In one embodiment, a Finite Element Model of the subject structural component is created that models the dimensions, material characteristics and physical parameters of the subject structure. A computer analysis (such as a Finite Element Analysis (FEA)) of the subject structural component is then conducted in order to examine the subject structure's dynamical behavior and to identify the appropriate higher-order resonant modes for that particular structural component.

In another embodiment, the resonant modes can be identified experimentally through a variety of methods. One method involves systematically exciting the structure across a wide range of frequencies, examining the response of the sensors as a function of the signal driving the actuators, i.e., examining the transfer function of the sensor response to the excitation drive signal. The peaks of the transfer function represent the resonant frequencies. Having identified the resonant frequencies of interest, the actuator will perform a sine sweep through a band of frequencies slightly above and below each resonant frequency of interest. The procedure will monitor exact changes in frequency and phase of each resonance peak that result from changes in prestress loading and temperature. A random signal can also be used instead of a sine sweep.

In one aspect, in order to minimize sensitivity to wave reflection from the boundaries of the structural element, a finite element analysis is performed in order to identify optimal spatial positioning of the wave actuators and wave sensors. This is accomplished by modeling wave behavior as it propagates from the actuator through the structural component and interacts or reflects at the boundaries of that particular component or with connecting structural mechanisms. Optimal spatial positioning locates both the wave actuator and wave sensor at points, known as nodes that minimize reflected wave amplitude.

In another embodiment, the FE analysis positions both wave actuators and wave sensors on the surface of the structural component in order to maximize sensitivity to the excitation of the intended resonant modes. This is accomplished by positioning wave sensors at a radius of action from the wave actuators that coincides with the anti-nodes, or points of maximum amplitude, of the resonant modes of interest.

After proper structural analysis and implementation of wave actuators and sensors, a calibration is performed to determine the relationship between changes in prestress load, changes in material temperature, and changes in structural resonant frequency response. This is done so that a given set of resonant frequencies corresponds to the magnitude of the prestress loading and temperature change. When calibrated, the present invention determines axial compressive or tensile loading, radial loading, bending moment loading, torsional loading and temperature change in a subject structural component by exciting resonant modes in the subject component, and measuring changes in both the frequency and the phase of those resonant modes as the subject's axial, radial or flexural prestress and temperature loads change.

When a plurality of a vehicle's or static structure's structural components are instrumented in this way, it is possible through a general structural calibration (see U.S. Pat. No. 6,415,242 to Weldon et al. and entitled “System for weighing fixed wing and rotary wing aircraft by the measurement of cross-axis forces,” which patent is hereby incorporated by reference) to deduce the both magnitude and distribution of the overall load on a structure.

One embodiment of a method of the invention can now be described by referring to the operation of the elements of the resonance load sensor system 10 of FIG. 1. The system computer/control unit 20 controls the actuator or actuators 14 to perform a frequency sweep procedure whereby the actuators excite a narrow band of frequencies around a known resonant frequency. The receiving sensor or sensors 16 then observe the structural response to excitation in the band range of excitation.

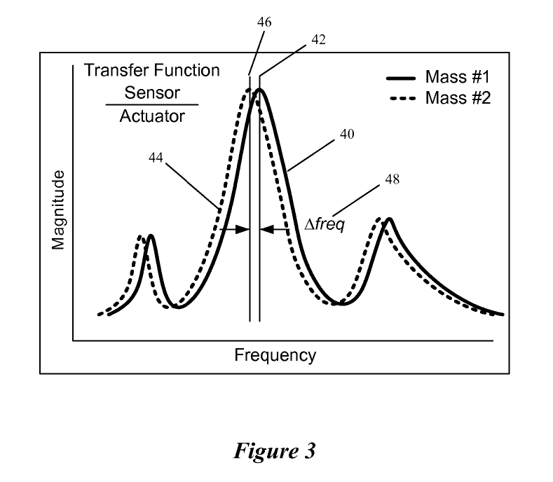

The system computer/control unit 20 employs its FFT unit 32 to perform a Fast Fourier Transform on the ratio of the sensor signal to the actuator signal for each sensor/actuator pair desired, converting the data from time domain to frequency domain. The computer/control unit then identifies the exact resonant frequency in any particular band by identifying the peak ratio in the transfer function as shown, for example, in FIG. 3. In FIG. 3, a magnitude/frequency plot for a first load 40 is illustrated, with a resonance apparent at the first load resonance frequency 42. This process can be performed for a plurality of sensor/actuator pairs, and for a plurality of bending modes (and associated resonant frequencies).

Using data from a calibration procedure as described above, the system computer/control unit 20 analyzes changes in resonance frequencies and determines the structural load changes that would generate such a resonant frequency change. The calibration procedure can be based on the results of a single resonant mode and associated frequency change, or on a plurality of such mode and frequency changes. For example, in FIG. 3, a magnitude/frequency plot for a second load 44 is illustrated, with a resonance apparent at the second load resonance frequency 46. By comparing the change in frequency 48 from the first load 40 to the second load 44, changes in the loading from the first to the second can be calculated.

In addition, the temperature will have to be determined. Embodiments of procedures for determining temperature use modal analysis: e.g., looking at how a specific mode changes with temperature, perhaps a mode that demonstrates sensitivity only to temperature, and not to prestress. A different procedure would use a non-modal analysis tool for determining temperature—such as a thermocouple.

Operationally, this procedure can be performed continuously or periodically, with data that describes changes in prestress updated with a response time that depends on a number of parameters, such as the frequency sweep bandwidth, the number of frequencies that are to be swept, the number of sensor/actuator pairs, the nature of the ambient or “vibrational daylight” excitation, and the processing speed of the data acquisition system.

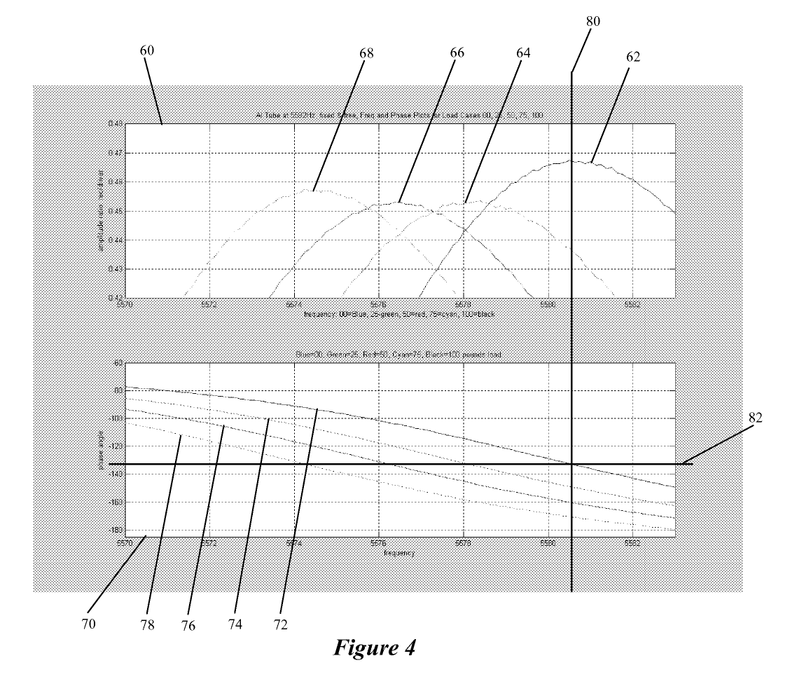

In one embodiment, the present invention measures loads by measuring changes in phase angle in resonant modes caused by changes in prestress loading through the use of a Phase Locked Loop (PLL), phase comparator or other phase measurement device operating at or near a resonance in a higher bending mode. This embodiment can be illustrated using the plots provided in FIG. 4. A first plot 60 shows an amplitude ratio plotted against frequency for five different loading conditions on an aluminum tube: unloaded or 0 pounds 62; 25 pound axial load 64; 50 pound axial load 66; and 75 pound axial load 68. The resonance frequency (apparent in plot 60 by the peak amplitude ratio for each loading) in the unloaded case is approximately 5580.5 Hz as shown by vertical line 80. As can be seen in the Figure, as the axial loading is increased, the resonance frequency drops. In addition, however, plot 70 (the second of the two plots in FIG. 4) indicates that for these same loadings (unloaded or 0 pounds 72; 25 pound axial load 74; 50 pound axial load 76; and 75 pound axial load 78), the phase angle at a given frequency (the 5580.5 unloaded resonance frequency, for example) shifts in a way that is proportional to axial loading.

Certain resonant modes are sensitive to temperature but not sensitive to changes in prestress, while all prestress modes exhibit sensitivity to temperature. Therefore, in order to accurately employ resonant frequency information in order to determine changes in prestress, it is necessary to first measure the temperature, and then apply that temperature measurement in order to identify the correct relationship between resonant frequency and prestress load. As a simple example of the method of exciting certain bending modes and measuring changes in the resulting natural frequencies in order to measure changes in temperature, consider this example.
The dynamic behavior of the structure or structural component is investigated so as to identify the bending modes that are not sensitive to axial loading.
Assume a test set-up whereby the structure or structural component structure is experiencing no external load or force.
The structure or structural component is subjected to thermal testing whereby the structure or structural component is heated and cooled throughout a range of temperatures.
At each of these temperature points, exact structure or structural component temperatures are measured using contact or non-contact temperature sensors, such as thermocouples.
Also at each of these temperature points, and with no axial, radial lr flexural loading being applied, certain non-axial bending modes are excited in the structure or structural component.
The exact peak resonant frequency then is recorded for each excited mode at each temperature point.
A calibration table is created that plots structure or structural component temperature vs. Resonant Frequency for each excited bending mode.

In operation, system 10 of FIG. 1 can be employed in this embodiment of the invention to measure changes in loading by measuring changes in the associated phase angle for a constant frequency as follows: One or more resonance modes of interest are selected, and a plurality of modes might be selected in order to achieve better system accuracy, and achieve improved system robustness through increased system redundancy. The system can be calibrated by applying actuator(s) 14 and sensor(s) 16 to measure both frequency and phase angle shift at resonance as a function of multiple loading conditions (weight and center of gravity location). Resonant frequency can be determined by applying Narrowband FFT 32 procedures with peak detection and using calibration data to calculate loading in the structure.

The system 10 records shifts in phase angle at given excitation frequencies (the resonant frequency of a selected mode of the unloaded structure) as a function of multiple loading conditions (weight and center of gravity location). This is accomplished by employing a phase lock loop, a phase comparison device, or other phase measurement device to record phase angle shifts at certain resonant frequencies as a function of multiple loading conditions (weight and cg location) in the signal conditioner 26 or onboard the computer/control unit in hardware or software.

The structure can then be excited using actuator(s) 14 at a constant frequency or by monitoring resonant states excited by ambient vibration, and changes in prestress loading can be measured by measuring changes in phase angle at that constant frequency. The system employs a phase lock loop, phase comparator or other phase measurement device to detect these shifts in phase angle at a fixed excitation frequency. Calibration data can be used to calculate axial, radial or flexural loading in the structure. More than one resonant mode can be used to increase accuracy.

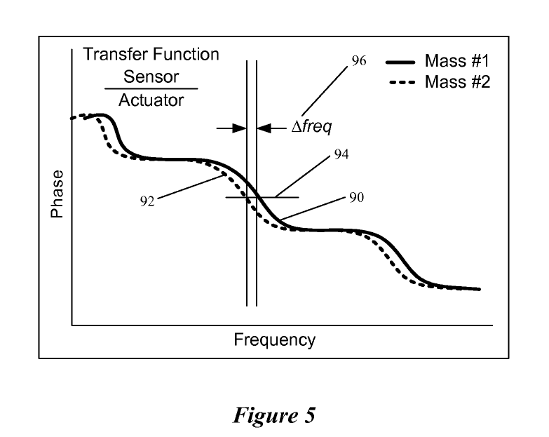

In another embodiment, a constant phase analysis can be used to determine resonant frequency. This embodiment can be illustrated by reference to the plot in FIG. 5, which shows phase angle versus frequency for a first load 90 and a second load 92. A horizontal “constant phase angle” line 94 can be constructed that intersects the phase lines 90, 92 of the different load cases. This line 94 can be drawn by starting at the phase value of the unloaded structure at resonance (as is also illustrated in FIG. 4 as horizontal line 82).

A system 10 (FIG. 1) according to this embodiment of the invention identifies an initial resonant frequency and associated phase angle through the use of calibration data. The computer/control unit 20 then acts to drive the signal generator 22 to maintain that phase angle as load conditions change by controlling actuator(s) 14 input frequency. This is accomplished by employing a phase lock loop device which adjusts input frequency to maintain phase angle. The computer/control unit 20 then uses calibration data and measures frequency states as a function of multiple loading conditions (weight and center of gravity location).

In operation, a system 10 according to this embodiment selects a specific initial resonance frequency, identifies the associated phase angle, and then controls the actuator 14 input frequency in order to maintain phase angle. The system 10 then measures changes in frequency to calculate changes in axial, radial or flexural loading. A plurality of resonance modes might be selected in order to achieve better system accuracy, and achieve improved system robustness through increased system redundancy.

The system 10 can be calibrated by measuring both frequency and phase angle shift at resonance as a function of multiple loading conditions (weight and center of gravity location). Resonant frequency is determined by applying Narrowband FFT 32 procedures with peak detection and using calibration data to calculate loading in the structure.

The system 10 can then record shifts in phase angle at given excitation frequencies (e.g., the resonant frequency of a selected mode of the unloaded structure) as a function of multiple loading conditions (weight and center of gravity location). A specific initial resonant frequency and associated phase angle can be selected for measurement. This can be accomplished by employing a phase lock loop, a phase comparison device, or other phase measurement device to record phase angle shifts at certain resonant frequencies as a function of multiple loading conditions. The system can then uses a Phase Lock Loop to maintain the selected phase angle by controlling the frequency of the actuator 14 input.

As the load changes, the system 10 senses changes in phase angle, and acts to maintain the desired phase angle by adjusting (controlling) the input frequency that is generated by the system actuator. The system monitors the new input frequency that is being used to maintain a constant phase angle, and uses calibration data to calculate the loading in the structure.

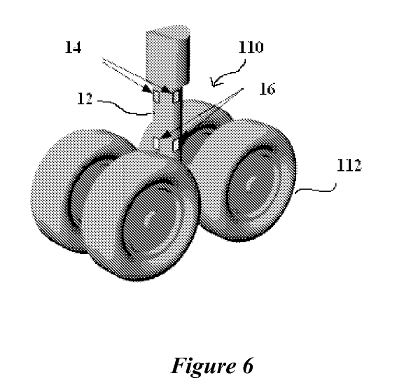

The Resonance Force Sensor system 10 of FIG. 1 can be deployed in certain embodiments for vehicle weight and balance measurement and monitoring. FIG. 6 shows an aircraft landing gear 110 having a ground contacting element 112, in this case wheels, and a structural element 12 extending upward from the ground contacting element. The perspective view of FIG. 6 shows two actuators 14 and two sensors 16 bonded to the structural element, however, a person of ordinary skill in the art will recognize that more or fewer sensors and actuators can be used.

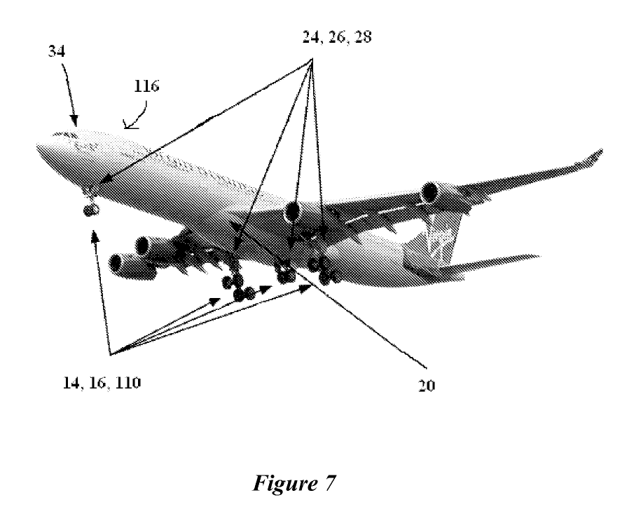

Turning now to FIG. 7, a resonance load sensor system 10 is deployed on an aircraft 116. The aircraft has a plurality of landing gear 110 having a plurality of actuators 14 and sensors 16 disposed on a structural element of each landing gear assembly. Certain electronics, such as signal conditioner 26, A/D Converter 28, Amplifier 24, and perhaps other elements, can be distributed on the aircraft. For example, by placing a number of A/D Converters 28 locally with respect to the actuators 14 and sensors 16 placed on landing gear elements 110, the central computer/control unit 20 can communicate with the remote (from the computer) electronics digitally over a wired or wireless digital network on the aircraft. A display unit 34 can be located in the cockpit of the aircraft 116 so that cockpit staff can see the results of the weight and balance sensing and calculations.

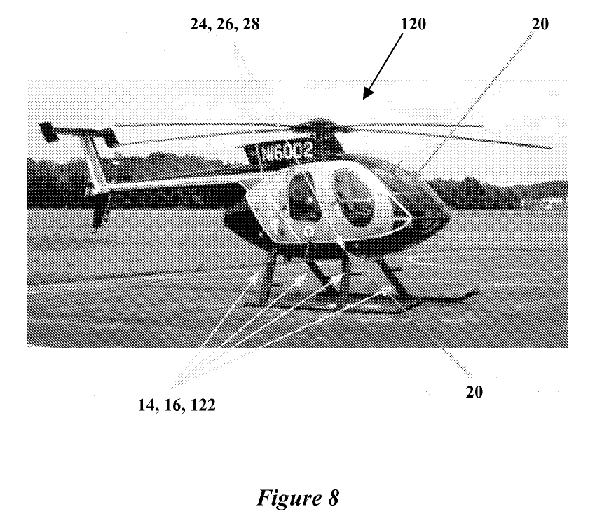

FIG. 8 illustrates a helicopter 120 having a resonance load sensor system 10 applied thereto. The helicopter 120 has a plurality of skid struts 122 having a plurality of actuators 14 and sensors 16 disposed on a structural element of each skid strut assembly. Certain electronics, such as signal conditioner 26, A/D Converter 28, Amplifier 24, and perhaps other elements, can be distributed on the helicopter. A display unit 34 can be located in the cockpit of the helicopter or externally to the helicopter to display the results of the weight and balance sensing and calculations.

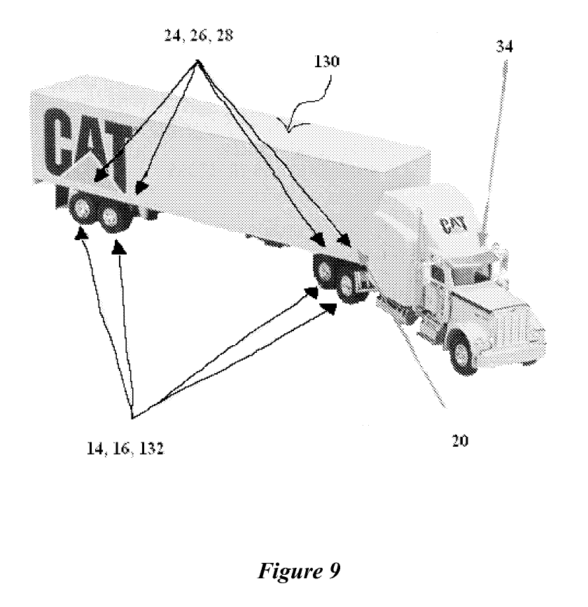

Turning now to FIG. 9, a resonance load sensor system 10 is applied to a truck 130. The truck 130 has a plurality of wheel assemblies 132 having a plurality of actuators 14 and sensors 16 disposed on a structural element of each wheel assembly. Certain electronics, such as signal conditioner 26, A/D Converter 28, Amplifier 24, and perhaps other elements, can be distributed on the truck. A display unit 34 can be located in the cab of the truck or externally to the truck to display the results of the weight and balance sensing and calculations.

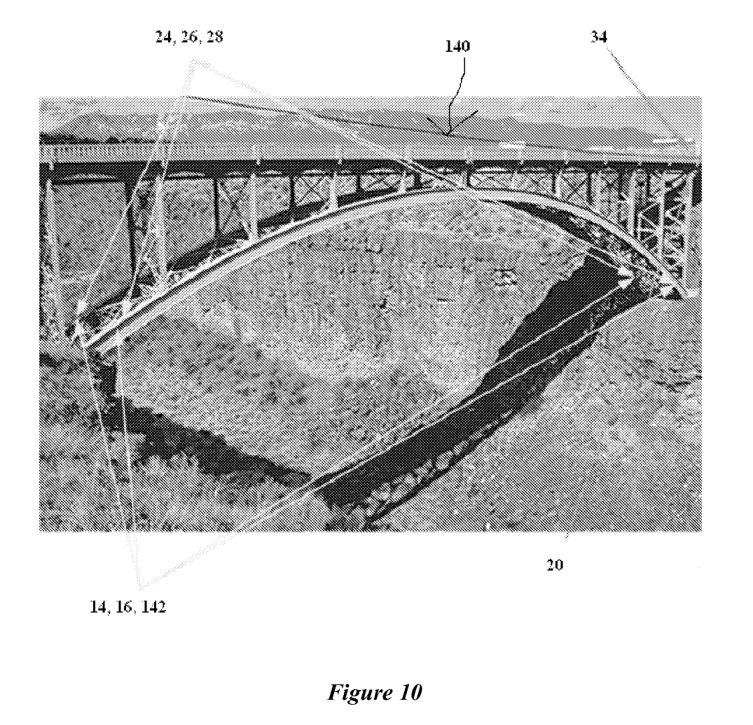

FIG. 10 shows a resonance load sensor system 10 applied to a stationary structure, such as bridge 140. A plurality of actuators 14 and sensors 16 are disposed on support struts 142 on the structure. Certain electronics, such as signal conditioner 26, A/D Converter 28, Amplifier 24, and perhaps other elements, can be distributed on the structure. The results of the sensing and/or weight and balance calculations can be transmitted over a wired or wireless network to a computer (that may be local or remote) for further processing and/or display 34 of the weight and balance results.

A person of ordinary skill in the art will appreciate further features and advantages of the invention based on the above-described embodiments. For example, specific features from any of the embodiments described may be incorporated into systems or methods of the invention in a variety of combinations, as well as features referred to in the claims below which may be implemented by means described herein. Accordingly, the invention is not to be limited by what has been particularly shown and described, except as indicated by the appended claims or those ultimately provided. Any publications and references cited herein are expressly incorporated herein by reference in their entity.

What is claimed is:

1. A method of measuring a load in an element comprising:
placing at least one sensor on the element, the at least one sensor being capable of sensing at least one of resonant vibrational frequency changes and phase angle changes indicative of changes in load on the element, the at least one sensor also measuring changes in temperature;
applying a computer control unit to operate the at least one sensor so as to measure at least one of a change in a resonance frequency in the element and a change in phase angle sensed by the at least one sensor as a result of a change in load on the member;
applying the computer control unit to measure changes in temperature, and to apply a temperature calibration to calculate the load on the member.

2. The method of claim 1, wherein the computer control unit is applied to measure a change in a resonance frequency.

3. The method of claim 2, wherein the resonance frequency corresponds to a higher order bending mode.

4. The method of claim 3, wherein the higher order bending mode is a second order or higher bending mode.

5. The method of claim 2, wherein the computer control unit is applied to measure a change in a resonance frequency at a plurality of bending mode resonance modes.

6. The method of claim 1, wherein the computer control unit is applied to measure a change in a phase angle.

7. The method of claim 6, wherein the computer control unit is applied to measure a change in a phase angle at a desired frequency.

8. The method of claim 1, further including an actuator exciting the vibrational frequencies.

9. The method of claim 1, wherein the at least one sensor measures vibrations that result from ambient vibrations.

10. The method of claim 1, wherein the at least one sensor includes a temperature sensor.

11. The method of claim 1, wherein the at least one sensor measures temperature by measuring a change in a resonant frequency that responds substantially to temperature changes.

12. The method of claim 1, wherein the at least one sensor includes an accelerometer.

13. The method of claim 1, wherein the at least one sensor communicates wirelessly.

14. The method of claim 1, wherein the actuator and sensor are disposed on at least one element of a vehicle, and the computer control unit is further programmed to calculate a load applied to the vehicle.

15. The method of claim 14, wherein the calculation of a load applied to the vehicle includes comparing measurements from the vehicle while loaded with calibration data for the vehicle under unloaded and known load situations.

16. The method of claim 15, wherein the calibration is a cross axis calibration.

17. The method of claim 14, wherein the vehicle is selected from the group consisting of an airplane, a helicopter, a marine vessel and a motorized ground vehicle.

18. The method of claim 1, wherein the calculation of load includes the calculation of radial pressure in a fluid line.

19. The method of claim 1, wherein the actuator and sensor are disposed on at least one structural element of a stationary structure.

20. A resonance load sensor system for performing the method of claim 1.
